(19) United States
(12) Patent Application Publication
(10) Pub. No.: US 2009/0073047 A1
(43) Pub. Date: Mar. 19, 2009

(54) Antenna System With Second-Order Diversity and Card for Wireless Communication Apparatus Which is Equipped With One Such Device

(75) Inventors: Francoise Le Bolzer, Rennes (FR); Franck Thudor, Rennes (FR); Geert Matthys, Broechem (BE); Francois Baron, Thorigne Fouillard (FR)

Correspondence Address: Robert D. Shedd;Thomson Licensing LLC, PO Box 5312, PRINCETON, NJ, 08543-5312, US

(73) Assignee: Thomson Licensing LLC

(21) Appl. No.: 11/988,776

(22) PCT Filed: Jul. 13, 2006
(86) PCT No.: PCT/FR2006/001737

§ 371 Date: Jan. 14, 2008

(30) Foreign Application Priority Data
Jul. 13, 2005 (FR) 0552194

(51) Int. Cl. H01Q 1/38

(52) U.S. Cl. 343/700 MS

(57) ABSTRACT

The present invention relates to an antenna system with a diversity order of 2 comprising on a same substrate comprising a metallization plane first and second radiating elements each constituted by an F-inverted type antenna printed on the metallization plane side, the first and second radiating elements being positioned perpendicularly to each other near the periphery of the substrate and being connected by their extremity forming a ground.

The present invention relates to a system of antennas with order 2 diversity. It also relates to a card for wireless communication comprising such an antenna system.

In the wireless communication domain, in particular within a room, multiple path phenomenona are observed. These phenomena can be very penalising for the quality of the received signal. Indeed one observes interference phenomena as well as signal fading.

To overcome these fluctuation problems in the received signals, diversity techniques are generally used. One of the solutions widely used in wireless communication devices of the WIFI type, consists in having two reception antennas and switching between one or the other of these antennas so as to chose the best one. To ensure a correct diversity, it is therefore necessary that both antenna are completely decorrelated. Hence, the antennas must be sufficiently distant from each other.

Hence, the most commonly used systems in the WIFI devices are constituted by two external antennas of the dipole type. This solution has the advantage of being easier to integrate since the antennas are thus linked to the wireless card by flexible coaxial cables. However, the cost of this solution is relatively high. Moreover, the antenna being an external part, it is fragile and can be easily destroyed or damaged.

To overcome these disadvantages, it has been attempted to integrate the antenna in the wireless card. Different techniques have therefore been proposed. Hence, in the US patent application 2003/0210191 published on 13 Nov. 2003, a description is given of an electronic card comprising on its periphery two PIFA type antennas (Planar Inverted-F-Antenna). In this case, both PIFA type antennas are each constituted by a radiating plate and two perpendicular tabs one forming a ground plane and the other forming a feeder line. This antenna therefore has a non-negligible thickness. Moreover, to obtain a good decorrelation of the antennas, both antennas are distant from each other. Therefore, the system described in this patent application remains cumbersome and requires the bonding of 3D metal components on the card. Moreover, in the US patent application 2003/022823 published on 4 Dec. 2003, a description is given of a bi-band antenna constituted by F-inverted type antennas realized in the RF screening foil of a mobile phone display. As in the case above, the antennas are distant from each other to obtain a good decorrelation of the said antennas.

The present invention relates to a very compact antenna system with a diversity order of 2, being easily integrated into an electronic card for wireless communication and having significant decorrelation properties.

The present invention therefore relates to an antenna system with a diversity order of 2 comprising, on a same substrate, first and second radiating elements positioned on two adjacent sides of the substrate near the periphery of the said substrate, characterized in that the substrate comprising a metallization plane, the first and second radiating elements are each constituted by an F-inverted type antenna printed on the metallization plane side of the substrate, the first and second radiating elements being positioned on the substrate at the level of the corner formed by the two adjacent sides and being connected to each other at the level of their extremity connected to the metallization plane. The invention thus defined has the form of an arrowhead.

Despite the proximity of the two antenna, this solution, which enables a very compact system to be obtained, has a good decorrelation of both antenna. The quality of the decorrelation obtained is far from being implicit for a person skilled in the art who would tend to distance the 2 radiating elements or add ground devices to provide this decorrelation as described in the documents of the prior art.

According to a first embodiment, the F-inverted type antenna is etched in the metallization plane.

According to another embodiment and in the case of multilayer substrates, the F-inverted type antenna is etched into at least 2 metallization planes of the substrate, each metal plane of the substrate thus etched and forming the body or strand of the F-inverted antenna being connected to each other by means of vias or metallized holes.

Moreover, the F-inverted type antenna is constituted by a conductive strand parallel to one side of the substrate, the conductive strand extending by one extremity part connected to the metallization plane of the substrate, the antenna being connected to an impedance matched feeder line perpendicular to the conductive strip.

Preferably, the resonance frequency of the conductive strand is given by the equation:

$$D 1 + H = \frac{c}{4 \cdot Fres \cdot \sqrt{{ɛ}_{eff}}}$$

wherein c is the speed of light in a vacuum, ε_{eff} the effective permittivity of the propagation environment, Fᵣₑₛ the resonant frequency, D1 the length of the conductive strand between its free extremity and the point of connection with the feeder line and H the height between the conductive strand and the metallization plane of the substrate.

According to another characteristic of the present invention, to improve the decorrelation between both of the radiating elements, a slot is realized at the level of their extremities connected to the metallization plane. The length of this slot can be chosen so that its resonant frequency corresponds to the resonant frequency of the antenna strands. This enables a widening of the operating band of the antenna to be obtained.

The present invention also relates to an electronic card for a wireless communication device featuring an antenna system with a diversity order of 2 as described above.

Other characteristics and advantages of the invention will appear upon reading the description of several embodiments, this description being realized with reference to the enclosed drawings, wherein:

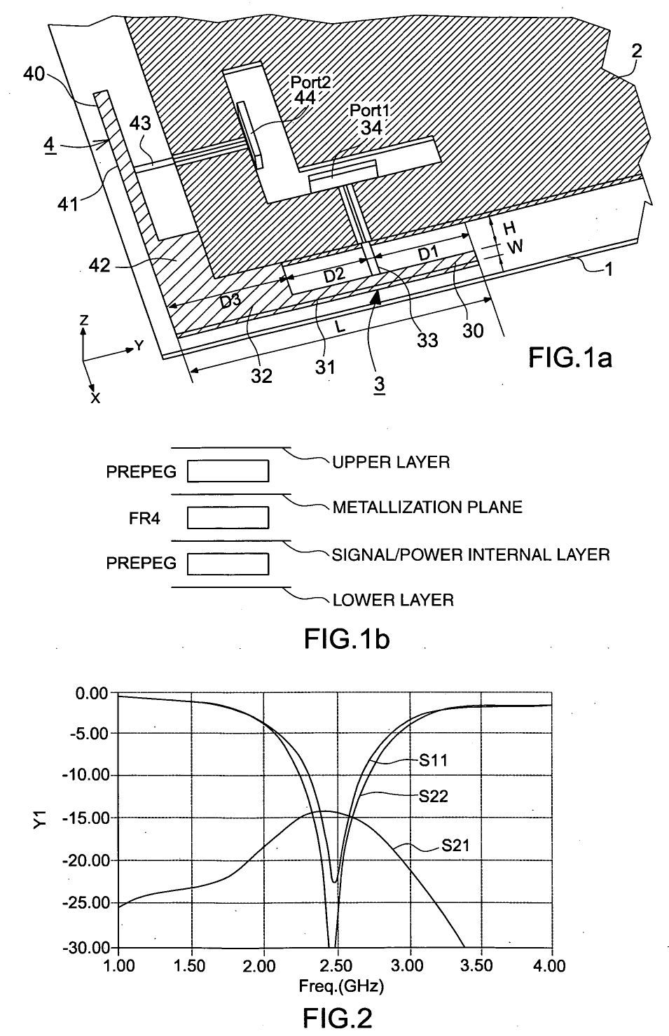

FIG. 1a is a partial perspective view of a first embodiment of a system in accordance with the present invention and FIG. 1b is a highly diagrammatic representation of the substrate used.

FIG. 2 represents the different impedance matching and isolation curves of the system of FIG. 1.

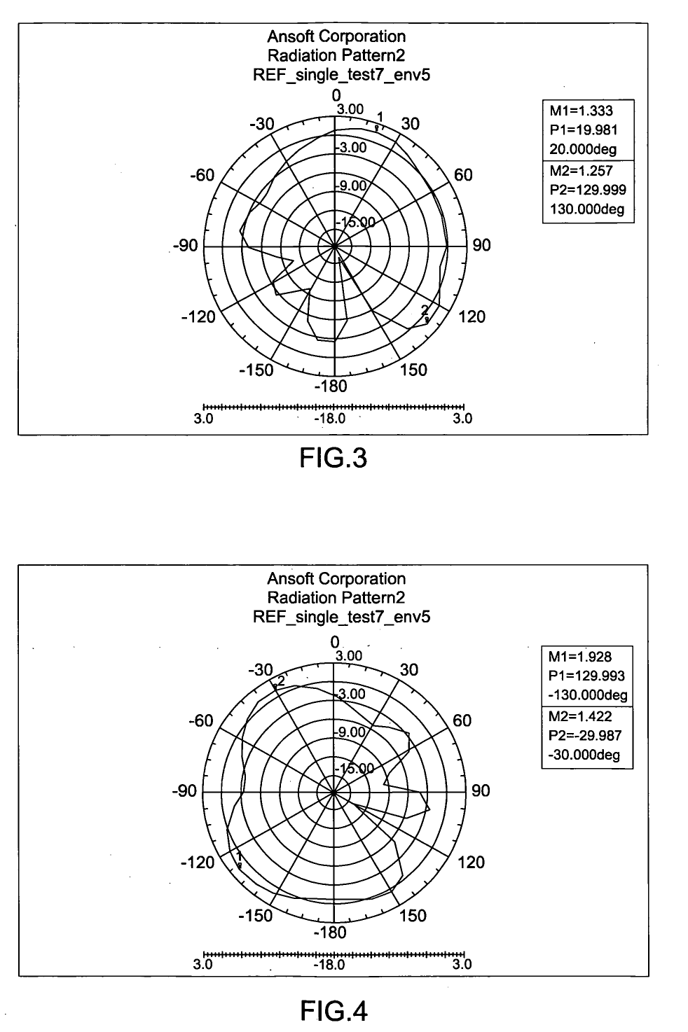

FIGS. 3 and 4 respectively represent the radiation patterns obtained by exciting one or other of the antennas in the system of FIG. 1.

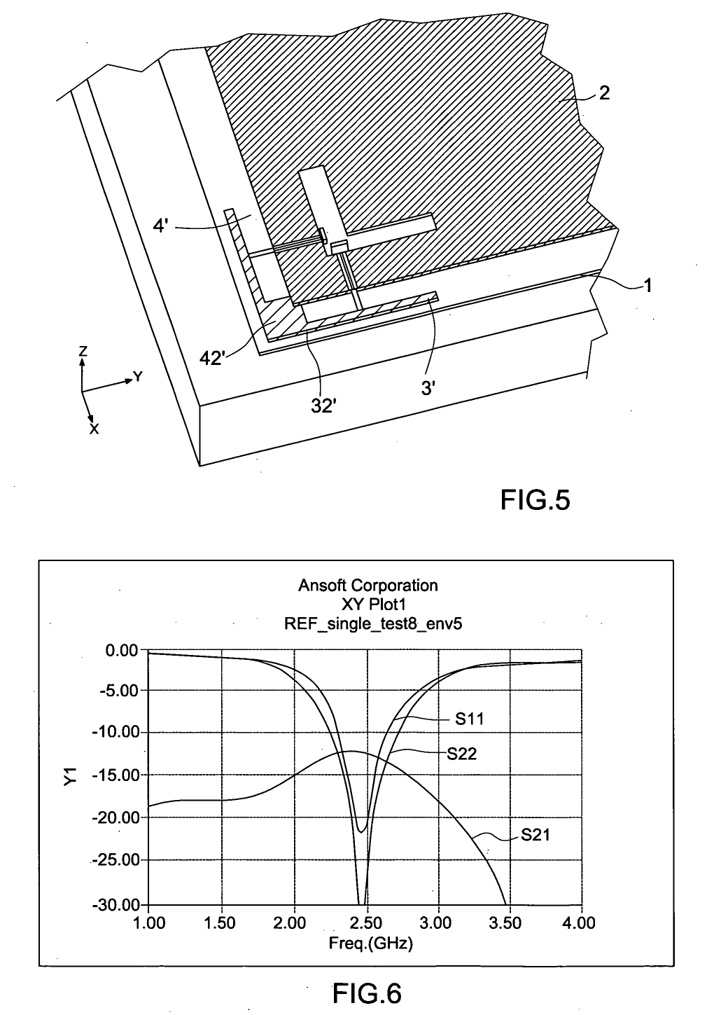

FIG. 5 is a partial perspective view of another embodiment of a system in accordance with the present invention.

FIG. 6 represents the impedance matching and isolation curves of the system of FIG. 5.

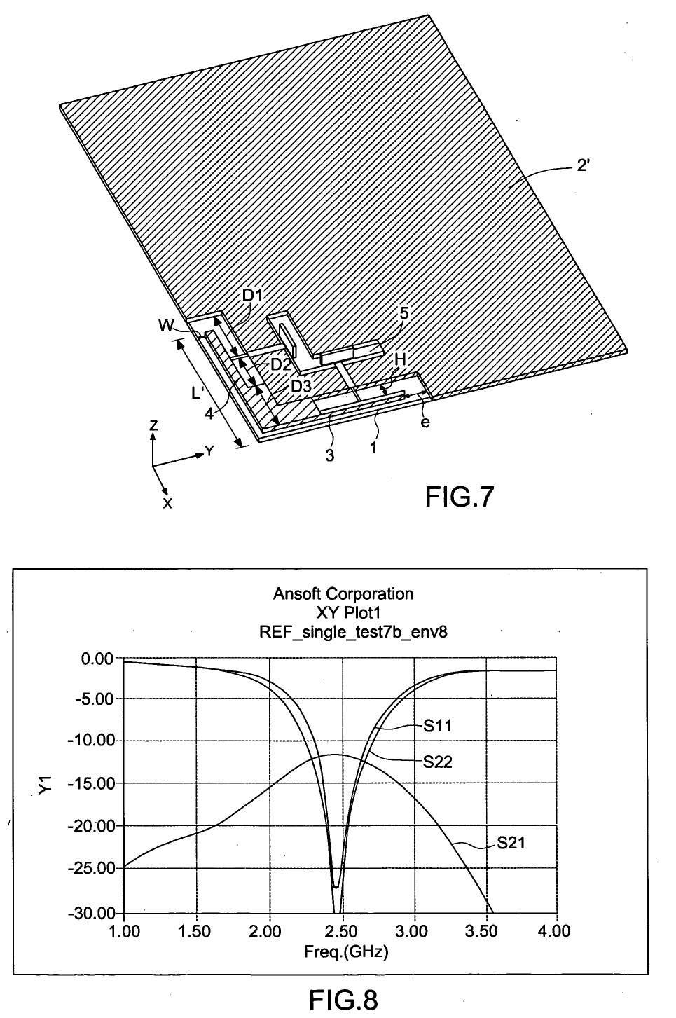

FIG. 7 is a partial perspective view of a third embodiment of the present invention.

FIG. 8 represents the impedance matching and isolation curves of the embodiment of FIG. 7.

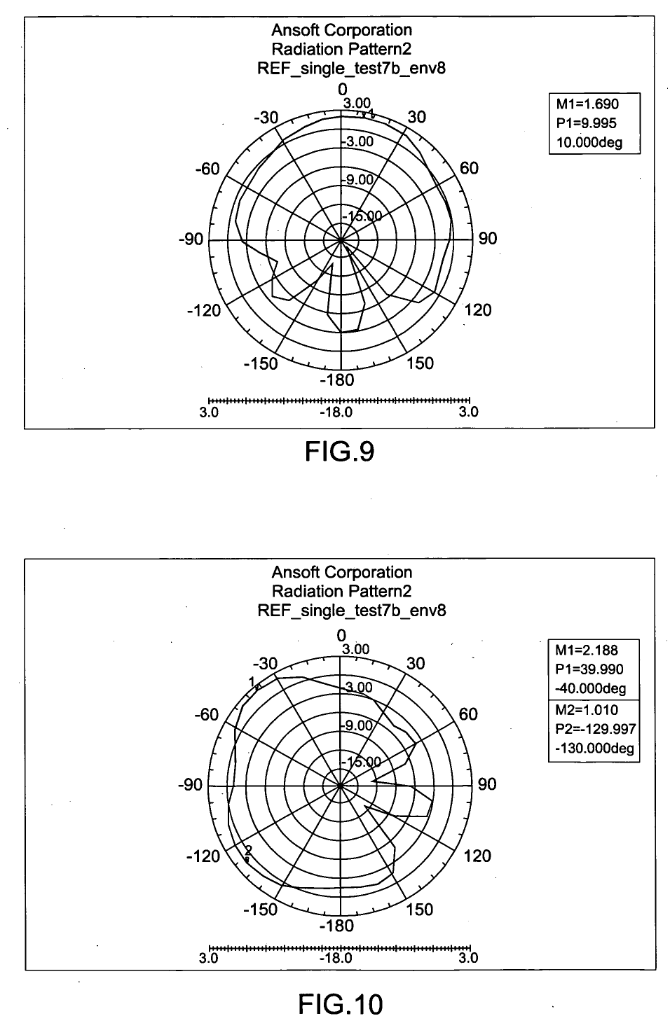

FIGS. 9 and 10 respectively represent the radiation patterns obtained by exciting one or other of the antennas in the system shown in FIG. 7.

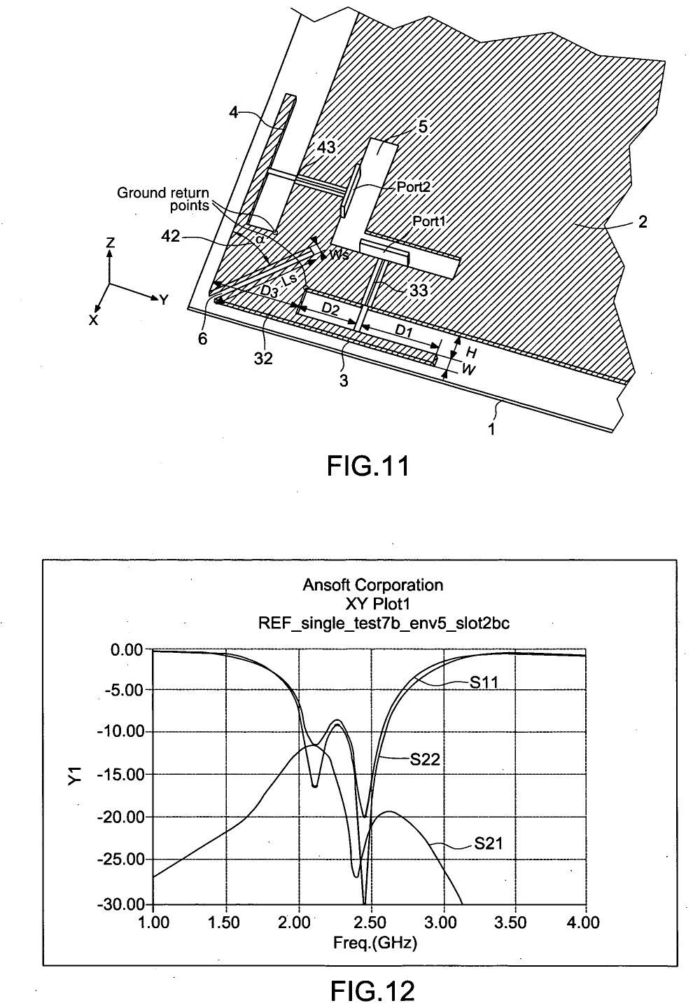

FIG. 11 is a partial perspective view of another embodiment of a system in accordance with the present invention.

FIG. 12 represents the different impedance matching and isolation curves of the system of FIG. 11.

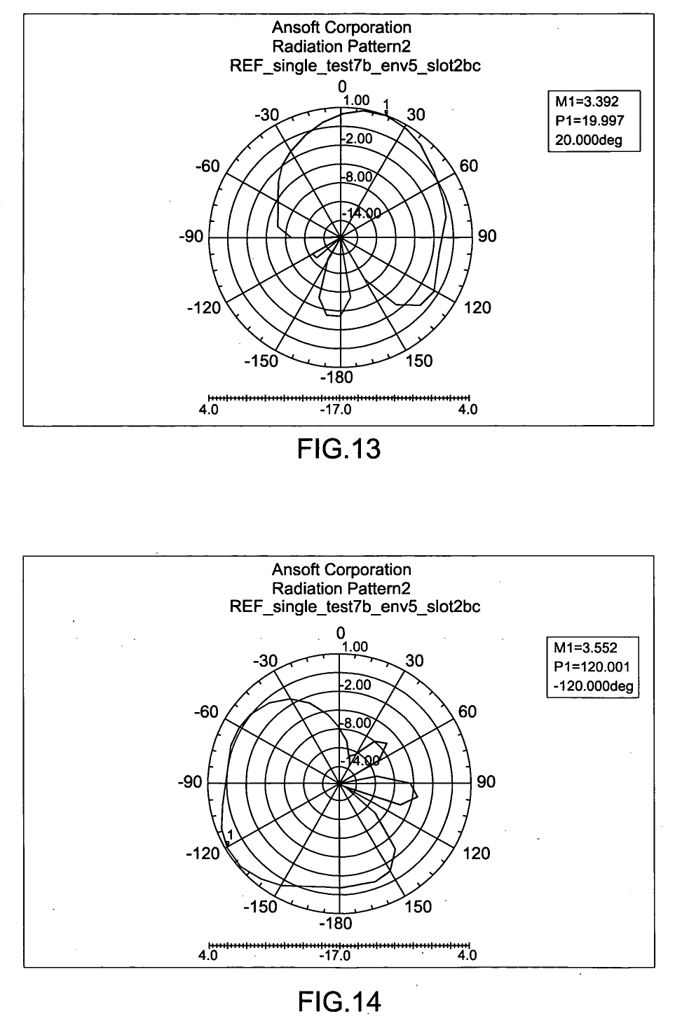

FIGS. 13 and 14 represent the radiation patterns obtained by exciting one or other of the antennas in the system of FIG. 11.

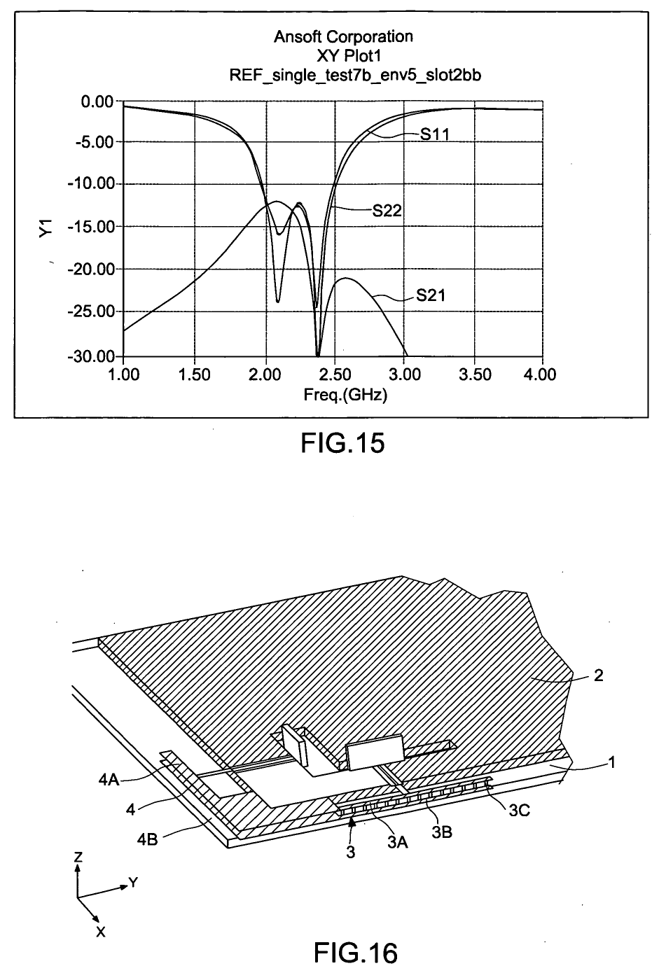

FIG. 15 represents the impedance matching and isolation curves of an antenna system according to the embodiment of FIG. 11 wherein the width of the slot has been optimised.

FIG. 16 is a partial perspective view of another embodiment of yet another antenna system in accordance with the present invention.

To simplify the description in the figures, the same elements have the same references.

A description will first be given with reference to FIGS. 1, 2, 3 and 4, of a first embodiment of an antenna system with a diversity order of 2 in accordance with the present invention.

As shown in FIG. 1a, on a substrate 1 with at least on its upper face a conductive layer forming a metallization plane 2, two antennas 3 and 4 of the F-inverted type have been realized. These antennas 3 and 4 are made by etching the ground plane 2 along the periphery of the substrate 1 in such a manner that the antennas 3 and 4 are perpendicular to each other while being connected by their extremities forming a ground. In this configuration, the antenna system has the form of an arrowhead.

In a more specific manner and as clearly shown in FIG. 1a, the antenna 3 that has a total length L and is found positioned along one edge of the substrate 1 comprises a conductive strand having a first part 30 of length D1 and a second part 31 of length D2. The part 31 extends by a part 32 forming a ground that is connected to the ground plane 2. The two parts 30, 31 are fed by a feed line 33 perpendicular to the conductive strand, to the junction point of the parts 30, 31. This feed line 33 terminates in a port 34 and is impedance matched to 50Ω. In a similar manner, the inverted antenna 4 comprises a conductive strand having a first part 40 extended by a second part 41 that is extended by a part forming a ground 42. This part 42 is connected to the part forming a ground 32 of the antenna 3 at the level of the external corner of the substrate. The parts 40, 41 are fed by a feed line impedance matched to 50Ω connected to the port 44.

In accordance with the present invention, the resonant frequency of the antennas 3 or 4 is obtained by the following equation:

$$D 1 + H = \frac{c}{4 \cdot Fres \cdot \sqrt{{ɛ}_{eff}}}$$

in which:

D1 is the length of the parts 30 or 40 of the conductive strand,

H is the height or dimension between the ground plan 2 and the conductive strand,

c is the speed of light in a vacuum,

ε_{eff} is the effective permittivity of the propagation environment, and

Fᵣₑₛ is the resonant frequency of the conductive strands.

In this case, the dimension D2 of the part 31 or 41 is chosen in such a manner as to play on the input impedance of the resonant part 30 or 40 of the conductive strand. Hence, at constant frequency, that if for H and D1 set, an increase (respectively decrease) in D2 will have the effect of reducing (respectively increasing) the input impedance of the resonant strand. The parts forming a ground 32 and 42 are connected to the ground plane. These parts have a length D3 of which the value constitutes a degree of freedom to integrate the antenna systems into an electronic card. Indeed, this part without current can hold attachment pins or other elements even metallic, enabling the integration of the card and providing the mechanical resistance of the whole.

A 3D simulation was carried out by using a commercial electromagnetic simulator based on the finite element method known under the HFSS Ansoft brand. This simulation was carried out by using an FR4 multilayer substrate having a total thickness of 1.6 mm and a permittivity Er of 4.4. As shown in FIG. 1B, the stacking of the substrate is constituted by an FR4 4 layer substrate comprising 2 external layers of a material known as Prepreg of 254 μm thickness and one internal FR4 layer of 889 μm thickness. The interface between the 3 substrate layers is constituted by 2 internal layers of copper of 35 μm thickness. The 2 external conductive layers or metallization plane are realized using 17.5 μm copper.

The feed line is defined on the upper layers 1 for the signal and ground plane 2 for the ground. For the simulation, the arrowhead is metallized on the entire thickness of the substrate, likewise for the ground plane.

The F-inverted type antenna system as shown in FIG. 1 has the following dimensions:

D1=14.4 mm

D2=12 mm

D3=18 mm

H=6 mm

W=2 mm

L=45.5 mm

A system of this type operates in the 2.4 GHz to 2.5 GHz frequency band.

In the case of this embodiment, both F-inverted type antennas are identical. However, it is obvious that within the context of the present invention, both antennas 3 and 4 can be of a different length, in such a manner as to operate on different frequency bands.

The results of the simulation give the impedance matching and isolation curves S11, S22 and S21 shown in FIG. 2. The curves S11 and S22 of FIG. 2 show an impedance matching greater then −15 dB on the two ports 32 and 42 over the entire bandwidth concerned, namely 2.4-2.5 GHz. Moreover, the isolation given by the curve S21 is −14 dB.

As shown in FIGS. 3 and 4 that respectively show in FIG. 3, the radiation of the antenna 3 and in FIG. 4, the radiation of the antenna 4, the two radiation patterns show a good decorrelation in relation to the axis of symmetry defined by the direction of the arrowhead in the patterns, said direction corresponding to Phi=−45°.

Hence, with a very compact antenna structure with a diversity order of 2, the two antennas being very close to each other and realized by using printed technology, a good decorrelation of the two antennas is obtained in a non-implicit manner for a person skilled in the art.

A description will now be given, with reference to FIGS. 5 and 6, of an embodiment variant of an antenna system in accordance with the present invention.

In this case, two antennas of the F-inverted type 3′, 4′ are realised by etching the metallization of a substrate 1 featuring a ground plane 2. To reduce the size even further, the antenna system shown in FIG. 5 has for each antenna 3′ and 4′, a part forming a ground 32′, 42′ whose length D3 has been reduced. A structure of this type was simulated, as mentioned above, taking a value of 10 mm for D3.

The results of the simulation are given by the curves of FIG. 6. In this case, impedance matching curves S11 and S22 are obtained showing an impedance matching greater than −15 dB over the 2.4 GHz to 2.5 GHz frequency band and an isolation curve S21 rising to −12 dB, the ground return points being closer owing to the fact of a lower D3 value.

A description will now be given, with reference to FIGS. 7 to 10, of another embodiment of an antenna system in accordance with the present invention. In this case, the F-inverted type antennas 3 and 4 are identical to the antennas of FIG. 1. However, as shown in FIG. 7, only a part of the ground plane 2′ laid on all the substrate 1 has been hollowed out. A system of this type was simulated by using an apparatus such as mentioned above.

The dimensions simulated in the embodiment of FIG. 7 are as follows.

D1=12.4 mm

D2=12 mm

D3=18 mm

H=6 mm

W=2 mm

L=43.5 mm

The distance e between the extremity of the strands and the ground plane 2′ is 7 mm.

As shown in the impedance matching S11, S22 and isolation S21 curves of FIG. 8, it is noted that the impedance matching remains very good for the frequency band around 2.5 GHz whereas the isolation represented by the curve S21 is −12 dB.

In an identical manner to the embodiment shown in FIG. 1, the diversity of the patterns is maintained, as it can be seen in the patterns of FIGS. 9 and 10 representing respectively the radiation of the antenna 3, FIG. 9 and the radiation of the antenna 4, FIG. 10.

A description will now be given, with reference to FIGS. 11 to 15, of an embodiment variant of an antenna system in accordance with the present invention. In this case, on a substrate 1 featuring a ground plane 2, the two F-inverted type antennas have been realized as in the embodiment of FIG. 1.

However, to improve the decorrelation between the F-inverted type antennas 3 and 4, the ground plane is etched at the level of the parts forming a ground 32 and 42. This etching operation forms a slot 6, as shown in FIG. 11. This etching operation enables the isolation between the two F-inverted type antennas 3 and 4 to be increased.

A structure such as represented in FIG. 11 was simulated by using the apparatus mentioned above. In this case, the following dimensions were used for the simulation, namely:

D1=15.4 mm

D2=12 mm

D3=18 mm

H=6 mm

W=2 mm

L=46 mm

The slot 6 has a width of 2 mm and a length of 23 mm. The slot realized in the ground plane is a rectangular slot placed on the axis of symmetry of the structure, as shown in FIG. 11, so as to maintain the symmetry of the patterns.

In FIG. 12 giving the impedance matching S11, S22 and isolation S21 curves for the system in FIG. 11, an improvement in the isolation between the two ports is noted, this isolation having values up to −22 dB. An impedance matching over the entire frequency band around 2.5 GHz is also noted.

The presence of the slot 6 thus enables the decorrelation between the radiation of the antennas 3 and 4 to be strengthened, as it can be seen in FIGS. 13 and 14 respectively showing the radiation pattern of the antenna 3 and the radiation pattern of the antenna 4.

It is possible to size the slot 6 in such a manner that its resonant frequency is close to that of the antennas 3 and 4. A widening of the operating band of the antenna is therefore obtained, as shown in FIG. 15. With respect to the slotless structure, the appearance of a second impedance matching peak (S11<−10 dB) is observed around 2.1 GHz corresponding to the resonance of the slot and which contributes to the impedance matching of the entire structure over the 2 GHz to 2.5 GHz band, namely a bandwidth of 22% against 16% for the slotless structure.

In FIG. 16, another embodiment of an antenna system in accordance with the present invention is shown. In this case, on a substrate 1 comprising at least one upper conductive layer and one lower conductive layer, two F-inverted type antennas were etched by etching a strand 3A on one face and a strand 3B on the other face of the substrate, likewise for the antenna 4. These strands 3A, 3B or 4A, 4B are connected by vias or metallized holes 3C as shown in FIG. 16. The advantage of this embodiment is the widening of the frequency band of a strand. FIG. 16 represents an F-inverted type antenna etched on 2 metal layers. However, the invention also applies to antennas etched on several layers connected by metallized holes.

It is evident to a person skilled in the art that the embodiments described above can be modified in many ways. With the invention, an antenna solution is obtained integrating a radiation diversity of the order of 2 compatible with the strictest cost constraints and very easily able to be integrated onto a motherboard for a wireless communication device such as a WIFI type device. The integration of the antenna system described above is possible on the entire wireless transmission device. The antenna accesses are impedance matched to 50 ohms and can be directly integrated into a switch of the type SPDT (Single Port Double Through) or DPDT (Double Port Double Through) and the size of the system is such that its use on cards already existing can be considered very easily.

1. Antenna system with a diversity order of 2 comprising, on a same substrate provided with a metallization plane, first and second radiating elements positioned on two adjacent sides of the substrate near edges of the said substrate, the first and second radiating elements being each constituted by an F-inverted type antenna printed on the metallization plane side of the substrate, the first and second radiating elements being positioned on the substrate at the level of the corner formed by the two adjacent sides and being linked to each other at an extremity of the F-inverted, said extremity being connected to the metallization plane.

2. System according to claim 1, wherein each F-inverted type antenna is etched in the metallization plane.

3. System according to claim 1, wherein each F-inverted type antenna is etched in at least two metallization planes of the substrate, the strands thus etched being connected by means of vias or metallized holes.

4. System according to claim 1, wherein the F-inverted type antenna comprises a conductive strand parallel to one side of the substrate, the conductive strand extending by one extremity part connected to the metallization plane of the substrate, the antenna being connected to an impedance matched feeder line perpendicular to the conductive strip.

5. System according to claim 4, wherein the antenna has a resonant frequency obtained by using the equation:
$$D 1 + H = \frac{c}{4 \cdot Fres \cdot \sqrt{{ɛ}_{eff}}}$$
wherein c is the speed of light in a vacuum, ε_{eff} the effective permittivity of the propagation environment, Fᵣₑₛ the resonant frequency, D1 the length of the conductive strand between its free extremity and the point of connection with the feeder line and H the height between the conductive strand and the metallization plane of the substrate.

6. System according to claim 4, wherein the length of the conductive strands of the two radiating elements is identical.

7. System according to claim 4, wherein the length of the conductive strands of the two radiating elements is different.

8. System according to claim 1, wherein a slot is realized between the two radiating elements at the level of their extremities connected to the metallization plane.

9. System according to claim 8, wherein the length of the slot is chosen so that its resonant frequency matches the resonant frequency of at least one antenna.

10. Electronic card for wireless communication device, featuring an antenna system with a diversity order of 2 according to comprising, on a same substrate provided with a metallization plane, first and second radiating elements positioned on two adjacent sides of the substrate near edges of the said substrate, the first and second radiating elements being each constituted by an F-inverted type antenna printed on the metallization plane side of the substrate, the first and second radiating elements being positioned on the substrate at the level of the corner formed by the two adjacent sides and being linked to each other at an extremity of the F-inverted, said extremity being connected to the metallization plane.
